(19) United States
(12) Patent Application Publication
(10) Pub. No.: US 2019/0331499 A1
(43) Pub. Date: Oct. 31, 2019

(54) METHOD AND DEVICE FOR UPDATING A DIGITAL MAP

(71) Applicant: Robert Bosch GmbH, Stuttgart (DE)

(72) Inventors: Ali Alawieh, Abstatt (DE); Carsten Hasberg, Ilsfeld-Auenstein (DE); Danny Hiendriana, Ludwigsburg (DE); Fabian Dominik Reister, Bad Liebenzell (DE); Jan-Hendrik Pauls, Grossbottwar (DE); Muhammad Sheraz Khan, Heilbronn (DE); Philipp Rasp, Wannweil (DE); Valentin Frommherz, Heilbronn (DE)

(21) Appl. No.: 16/475,152

(22) PCT Filed: Dec. 5, 2017
(86) PCT No.: PCT/EP2017/081431

§ 371 Date: Jul. 1, 2019

(30) Foreign Application Priority Data
Feb. 2, 2017 (DE) 10 2017 201 669.8

(51) Int. Cl. G01C 21/32; G01C 21/34

(52) U.S. Cl. CPC G01C 21/32; G01C 21/3407

(57) ABSTRACT

A method, a processing unit which carries out the method, and a system including the processing unit for updating a digital map for locating motor vehicles are provided. In the case of the method for updating a digital map for locating motor vehicles, surroundings information is detected by a vehicle for the purpose of updating the digital map and the detected surroundings information is compared to the surroundings information which is stored on the digital map. In this case, the vehicle is located on the digital map, which means that the location or position of the vehicle on the digital map is known. For the purpose of detecting the surroundings information, the vehicle is navigated along a first route, whose most recently carried out comparison of surroundings information dates back the longest as compared to at least one further optional route.

### BACKGROUND INFORMATION

Highly accurate digital maps which represent reality in a preferably error-free manner are important for highly or fully automated driving, since motor vehicles are located with the aid of these maps and are thus able to orient themselves to their surroundings.

The present invention relates to a method, a processing unit, and a system including the processing unit for updating a digital map for locating motor vehicles.

German Patent Application No. DE 10 2008 012 661 A1 describes an updating device for updating a digital map for a motor vehicle. The updating device includes a plurality of sensors which measure the instantaneous traffic situation, the movement of the vehicle, or also the road conditions. These measured values are transferred to a control center which evaluates them and then transmits corresponding updating data to other vehicles for the purpose of updating their digital maps. For example, a traffic jam on a route may be established and other vehicles may avoid this traffic jam by taking a detour route.

German Patent Application No. DE 10 2008 053 531 A1 describes an evaluation module for evaluating the data of a digital map for a motor vehicle. Here, information about the measuring accuracy of the data or about an up-to-dateness of the data is stored and compared to the measured data of the surroundings sensors of the vehicle. The result of the evaluation is subsequently transferred to a driver assistance system or a safety system of the vehicle. The system may then decide as to what extent it wants to use the digital map data.

An object of the present invention is to provide a method for improving the use of digital maps in motor vehicles, in particular in the case of highly or fully automated driving.

### SUMMARY

An example method, example processing unit, which carries out the method, and example system including the processing unit for updating a digital map for locating motor vehicles are provided according to the present invention.

In the case of the example method for updating a digital map for locating motor vehicles, surroundings information is detected by a vehicle for the purpose of updating the digital map and the detected surroundings information is compared to the surroundings information which is stored on the digital map. In this case, the vehicle is located on the digital map, which means that the location or position of the vehicle on the digital map is known.

This locating my take place, for example, in that the vehicle detects a landmark and orients itself based on same. In this context, a landmark is an object whose location is stored very precisely in the digital map and whose location does not change. One example of such a landmark is, for example, an erected monument at the roadside. Landmarks may, however, also be situated artificially in the surroundings. This means that these landmarks were situated deliberately in the surroundings for locating purposes.

By comparing the detected and the stored surroundings information, it is possible to check whether the map data match the instantaneous position and surroundings of the vehicle. On the one hand, it is possible to determine in this case to what extent the surroundings of the map have changed since the last update and, on the other hand, it is, however, also possible to detect inaccuracies in the surroundings information, which is stored in the digital map.

The vehicle which detects the surroundings information is, for example, a vehicle which is steered manually, however even a vehicle which is operated in a highly or fully automated manner may also be involved. On the one hand, a vehicle may be involved which only serves the purpose of updating a digital map; on the other hand, a vehicle may be involved which is primarily used for passenger transportation and whose vehicle owner carries out the update of the map voluntarily or for a fee while commuting to work or back. In the case of this vehicle, a motor vehicle is preferably involved; a non-motorized vehicle including appropriate surroundings sensors may, however, also be involved, for example.

For the purpose of detecting the surroundings information, the vehicle is navigated along a first route, whose most recently carried out comparison of detected surroundings information and surroundings information which is stored in the digital map dates back the longest as compared to at least one further optional route. The vehicle thus has a choice between several routes, the choice being made in favor of that route whose validation or check of the validity of the surroundings information dates back the longest. In the case of such correspondingly outdated routes which guide through the map sections of a digital map, it may occur, for example, that the routing of a road has completely changed over time due to a construction site, for example. One advantage of the method is that it may thus be ensured that a digital map is kept preferably up to date in its entirety, including all map sections contained therein.

The first route and the at least one further optional route preferably include a shared destination or a shared intermediate destination. Possible routes toward the shared destination are then compared with regard to a recently carried out comparison of the surroundings information. This has the advantage that the vehicle, which detects the surroundings information, does not drive aimlessly through the digital map, but has a fixed destination. A shared destination may represent the workplace or also a gas station, for example.

The first route and the at least one further optional route preferably run at least partially along traffic lanes which are situated next to one another and which are separated by roadway markings. This has the advantage that on expressways, for example, the traffic lane selected as the first route is the one whose comparison of surroundings information dates back the longest as compared to another traffic lane. If, for example, a passenger car is used as the vehicle which detects surroundings information, the view toward the right-hand roadside is often blocked by trucks on expressways.

By selecting the route, it is possible, for example, to ensure that every now and then a vehicle drives in the right traffic lane and detects the surroundings information there to compare it to the surroundings information which is stored in the digital map. Alternatively or additionally, the first route and the at least one further optional route run at least partially along traffic lanes which are spatially separated. This may occur, for example, when on an expressway, the lanes branch out in the same direction due to a construction site and partially continue on different sides of the construction site. Here, it would now be possible that that traffic lane is selected as the route for detecting and comparing the surroundings information, whose comparison of surroundings information dates back the longest as compared to another traffic lane. This could also mean, for example, turning from a main road into a side road which is driven relatively rarely. It is thus ensured that the digital map is kept up to date in its entirety, even in the case of map sections which are driven relatively rarely.

The first route and the at least one further optional route preferably intersect in sections. These so-called junctions of the digital map may be used, for example, again and again as starting points for selecting a first route. At these junctions, it is possible to check again and again which route is selected over another route by means of a comparison of surroundings information which dates back the longest. Such junctions thus offer the advantage that the first route must be selected only up to such a next junction and thus computing power may be saved. One example of such a junction is an intersection. Alternatively or additionally, the first route and the at least one further optional route may run on top of each other in sections. The first route and the at least one other route are thus identical in sections. This makes it possible to save computing power, since it is not necessary to select between different routes in such situations. Such a situation may occur, for example, in the case of entering a one-lane state road via an on ramp, the on ramp and the state road each representing an individual route.

The surroundings information preferably represents location information, i.e., corresponding to the positions of the surroundings objects. If the vehicle which detects the surroundings information is located on the digital map, the distances to detected objects in the surroundings may be detected and thus their locations may be detected. These detected locations of the surroundings objects may be thereupon compared to the locations of the surroundings objects which are stored in the digital map and differences in the measured data may thus be established. Alternatively or additionally, the surroundings information represents the kind of the detected surroundings objects, i.e., the types of the detected objects. If, for example, no street sign is detected in a position of the vehicle in which a street sign was previously detected in the surroundings, it is safe to assume that it was removed. Modified road profiles may thus also be established, for example.

As a function of the comparison between the detected and the stored surroundings information, the stored surroundings information is preferably updated on the digital map. For example, it may occur that in the surroundings of the vehicle, a surroundings object is detected which is not charted on the digital map. It would be advantageous in this case to add the newly added surroundings object to the digital map as new surroundings information (landmark). It is, however, also possible to add that only differences with regard to the measured data of a location of a surroundings object are established. In this case, the mean value between the stored measured data and the newly detected measured data may be formed, for example, in order to update the new location of the surroundings object on the digital map.

The first route, along which the vehicle is navigated, is preferably ascertained as a function of the updated information which is stored on the digital map and which is assigned to the surroundings information. The digital map correspondingly includes information about the last time a map element was detected and compared. The more time has passed since a certain map element was viewed, the more important may its weighting be, for example. Map sections including many map elements which have not been detected for a longer period of time are given a great weighting overall and are preferred over map sections which have a lesser weighting overall when navigating the vehicle.

The present invention additionally includes a system which encompasses at least one processing unit, a memory unit, a positioning unit, a surroundings detection device, and an output unit. The processing unit, which represents the processor of a navigation system, for example, carries out the above-described method for updating a digital map for locating motor vehicles. The processing unit is designed to compare the surroundings information which is detected by a located vehicle and the surroundings information which is stored on a digital map to one another. Additionally, the processing unit is designed to navigate the vehicle along a first route, whose most recently carried out comparison of surroundings information dates back the longest as compared to at least one further optional route. The processing unit is preferably also designed to update the surroundings information which is stored on the digital map as a function of the comparison between the detected and the stored surroundings information. The memory unit which represents a hard drive or a memory medium of a navigation device, for example, is designed to store the digital map. The positioning unit is designed to detect the instantaneous location of a vehicle on the digital map. In this case, the positioning unit may represent a GPS signal unit, for example. The positioning unit may optionally represent a direction sensor, a distance travel sensor, and, potentially, a steering wheel angle sensor if coupled navigation is used. It is also conceivable that the positioning unit represents a GSM and/or UMTS signal unit, so that the position determination may take place via cell positioning. The surroundings detection device of the system is designed to detect surroundings information. The surroundings detection device may thus represent a camera, for example, with the aid of which object types, such as lane markings or traffic signs, may be detected, for example. Alternatively or additionally, the surroundings detection device may represent an ultrasonic sensor and/or a LIDAR sensor and/or a radar sensor, for example, with the aid of which distances from objects may be ascertained. The output unit of the system is designed to output the updated digital map. For this purpose, the output unit may, for example, represent a display, for example a display of a navigation device and/or a loudspeaker for outputting information about the digital map.

### BRIEF DESCRIPTION OF THE DRAWINGS

FIG. 1 shows one specific embodiment of the processing unit according to the present invention.

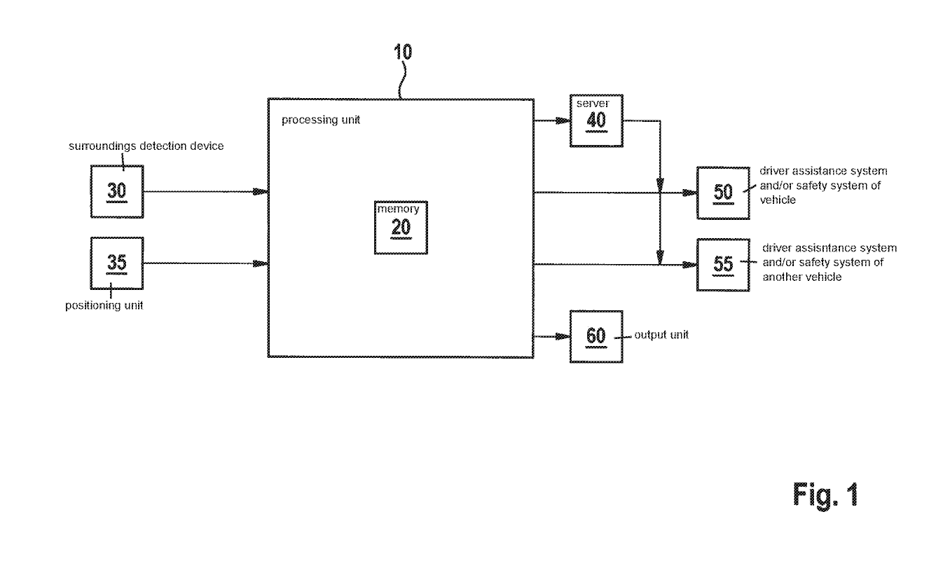

FIG. 2 shows a method sequence according to the present invention for updating a digital map for locating motor vehicles.

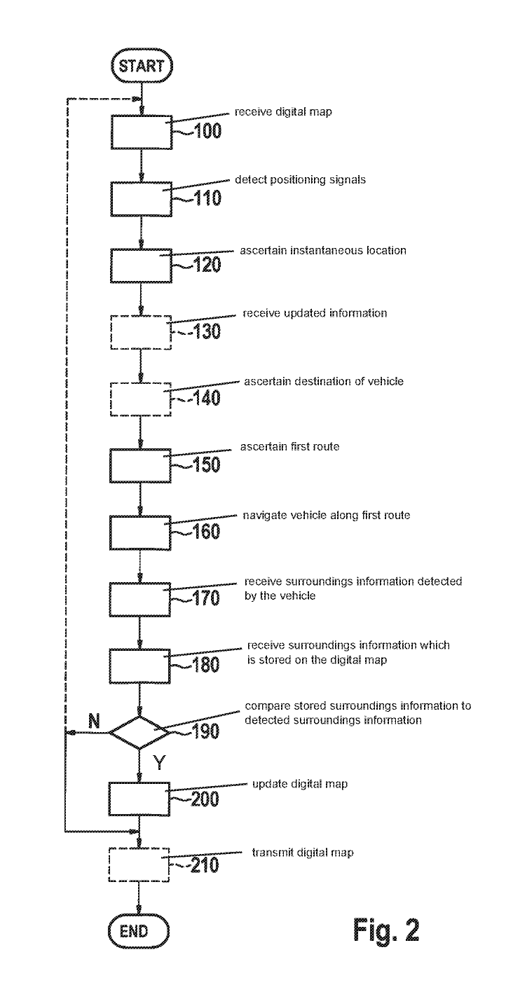

FIG. 3 schematically shows the selection of a route along which a vehicle is navigated for the purpose of detecting surroundings information.

### DETAILED DESCRIPTION OF EXAMPLE EMBODIMENTS

Processing unit 10 is designed in this case to receive a stored digital map from a memory unit 20. In this exemplary embodiment, memory unit 20 is integrated into processing unit 10, but it may also be located outside of the processing unit, for example in a data cloud. Additionally, processing unit 10 is designed to receive positioning signals of a vehicle from a positioning unit 35 and to locate the vehicle on the digital map as a function of the positioning signals. Processing unit 10 is also designed to navigate the vehicle as a function of the stored digital map along a first route, whose most recently carried out comparison of surroundings information dates back the longest as compared to at least one further optional route. For this purpose, updated information of the surroundings information on the digital map may be used, for example. Additionally, processing unit 10 is designed to receive surroundings information which is detected with the aid of surroundings detection device 30 of the vehicle and to compare same to the surroundings information which is stored on the digital map. Processing unit 10 is furthermore designed to transmit the updated digital map to an output unit 60. Output unit 60 may involve the display of a navigation device, for example.

Processing unit 10 may be optionally designed to transmit the updated map to a driver assistance system and/or a safety system 50 of the vehicle which detects the surroundings information. Depending on how fast the data are transferred and processed in this case, the vehicle may still use the updated digital map for the present trip or not until later trips.

Processing unit 10 may be furthermore optionally designed to transmit the updated map to a driver assistance system and/or a safety system 55 of a further vehicle. In this way, it may be ensured for highly or fully automated driving, for example, that the digital map is always up to date.

Optionally, processing unit 10 may be furthermore designed to transmit the digital map to a server 40, which other motor vehicles may also have access to and whereby the digital map may be additionally stored as a safety measure, for example. In this case, the server may represent a data cloud, for example. Alternatively, it would be conceivable in this case to integrate the processing unit into the server, thus saving computing capacity within the vehicle. In turn, it may be optionally provided via server 40 to transmit the updated digital map to a driver assistance system and/or a safety system 50 of the vehicle and/or to a driver assistance system and/or safety system 55 of another motor vehicle.

In a first specific embodiment of the method for updating a digital map for locating motor vehicles, a digital map is received following the start of the method in a method step 100. In a subsequent method step 110, positioning signals of a vehicle are detected. Thereupon, the instantaneous location of the vehicle on the digital map is ascertained in a method step 120 and the vehicle is thus located on the digital map. In a next method step 150, a first route is ascertained, whose most recently carried out comparison of surroundings information dates back the longest as compared to at least one further optional route. The vehicle is navigated along this first route in a next method step 160. In a next method step 170, surroundings information is received which is detected by the vehicle on this first route. In a next method step 180, surroundings information which is stored on the digital map is received. In a method step 190, which follows method step 180, the stored surroundings information is compared to the surroundings information which is detected by the located vehicle. It is checked in this case, to what extent the surroundings information which is stored on the digital map is in fact present in the locations which are stored in the digital map. This takes place by checking the deviation which is established through the comparison of the surroundings information. If a deviation, such as a measurement deviation or a completely new surroundings object, is established, the digital map is updated in method step 200. If no deviation is established in method step 190, the method is terminated or alternatively restarted.

In a second specific embodiment of the method, updated information which is stored on the digital map and which is assigned to the surroundings information is received in a method step 130, which follows method step 120, in addition to the method steps illustrated in the first specific embodiment. The ascertainment of the first route in method step 150 is subsequently carried out as a function of this received updated information.

In a third specific embodiment of the method, a destination of the vehicle is ascertained in method step 140, which follows method step 130, in addition to the method steps illustrated in the first and second specific embodiments. The destination may be ascertained as a function of an input signal of the driver, for example. The first and the at least one further optional route may thus encompass a shared destination.

In a fourth specific embodiment, the method steps which are illustrated in the previous specific embodiments are carried out. Here, the surroundings information represents the location information of the surroundings objects.

In a fifth specific embodiment, the method steps which are illustrated in the previous specific embodiments are carried out. Here, the surroundings information represents information about the type of the surroundings objects.

In a sixth specific embodiment of the method, the digital map is updated in method step 190 by updating the corresponding surroundings information which is stored on the digital map, in addition to the method steps illustrated in the previous specific embodiments. This may correspondingly involve a correction of already present surroundings information as well as the addition of new surroundings information.

In a seventh specific embodiment of the method, the digital map is transmitted in a method step 210, which follows method step 200, to a driver assistance system and/or safety system of the located vehicle itself or to a driver assistance system and/or safety system of further motor vehicles, which use the digital map for locating purposes, in addition to the method steps illustrated in the previous specific embodiments.

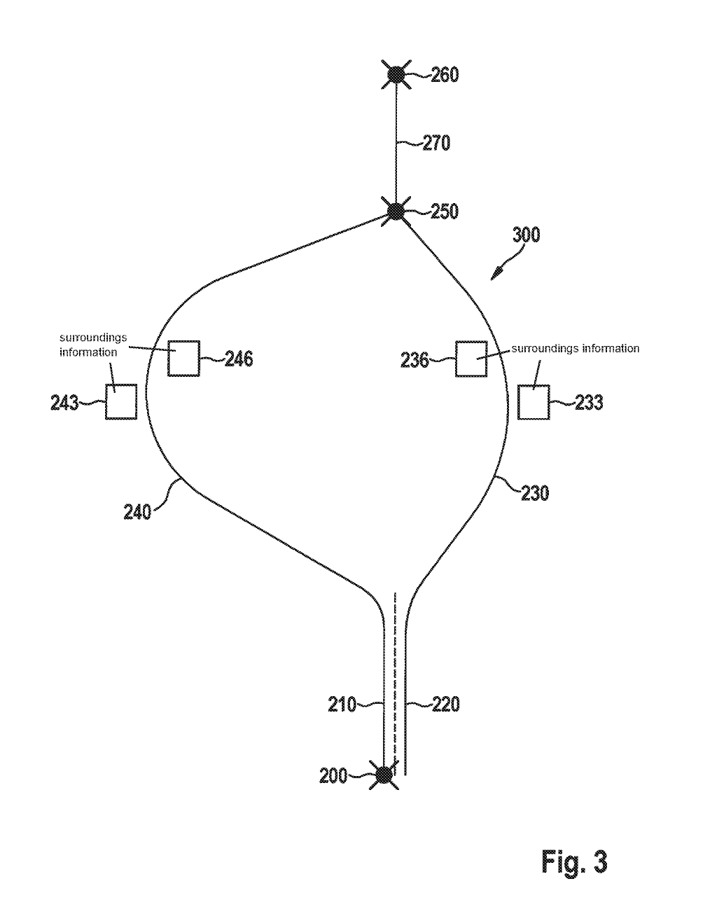

FIG. 3 schematically shows the selection of a route on a digital map 300 along which a vehicle is navigated for the purpose of detecting surroundings information.

Here, the vehicle is initially located on starting point 200 on digital map 300. Lines 210, 220, 230, 240, and 270 represent road sections in this case, while point 250 represents an intersection. Point 260 represents the destination of the vehicle, for example the workplace of the driver of the vehicle. That route is selected as the route to the destination whose most recently carried out comparison of surroundings information dates back the longest as compared to at least one further optional route. In this example, it may be selected between the routes via road sections 210, 240, and 270 or the route via road sections 220, 230, and 270. The routes correspondingly run through the map sections of the digital map. The individual road sections of the digital map are assigned pieces of surroundings information 213, 233, 236, 243, and 246. These may represent traffic signs or also lane markings, for example. The more time that has passed since a piece of surroundings information 213, 233, 236, 243, and 246 was detected, the greater is the weight of corresponding piece of surroundings information 213, 233, 236, 243, and 246, for example. Now, if a longer period of time has passed since a comparison of pieces of surroundings information 213, 233, 236, 243, and 246 had been carried out in a road section, the pieces of surroundings information are weighted correspondingly high and the entire road section is thus given a high weighting.

The vehicle is navigated along the route which includes the highest overall weighting. In this case, it may happen that the first route which is selected for navigating the vehicle and the at least one further optional route coincide in sections. This is the case in this example on road section 270. As is apparent here by way of example in road sections 210 and 220, the routes may run at least partially along traffic lanes which are situated next to one another and which are separated by roadway markings. The first route and the at least one further optional route may also run at least partially along traffic lanes which are spatially separated. This is illustrated here by way of example in road sections 230 and 240. If, for example, the route through road sections 210, 240, and 270 has the higher weighting, it also may possibly happen, as is apparent, that a route is selected which is longer, with regard to the traveled distance, than the further optional route through road sections 220, 230, and 270.

1-10. (canceled)

11. A method for updating a digital map for locating a motor vehicle, comprising:
detecting pieces of surroundings information by a vehicle located on the digital map for updating the digital map;
comparing the detected pieces of surroundings information to pieces of surroundings information which are stored on the digital map; and
navigating the vehicle along a first route, whose most recently carried out comparison of the pieces of surroundings information dates back the longest as compared to at least one further optional route.

12. The method as recited in claim 11, wherein the first route is ascertained as a function of the updated information which is stored on the digital map and which is assigned to the pieces of surroundings information.

13. The method as recited in claim 11, wherein the first route and the at least one further optional route include a shared destination.

14. The method as recited in claim 11, wherein the first route and the at least one further optional route run at least partially along traffic lanes which are situated next to one another and which are separated by roadway markings or which are separated spatially from one another.

15. The method as recited in claim 11, wherein the first route and the at least one further route intersect and/or run on top of each other in sections.

16. The method as recited in claim 11, wherein the pieces of surroundings information represent location information of detected surroundings objects and/or information about a type of the detected surroundings objects.

17. The method as recited in claim 11, wherein as a function of the comparison between the detected and the stored surroundings information, the stored surroundings information is updated on the digital map.

18. A processing unit configured to update a digital map for locating a motor vehicles, the processing unit being configured to compare pieces of surroundings information which are detected by a vehicle located on the digital map to pieces of surroundings information which are stored on the digital map, wherein the processing unit is additionally designed to navigate the vehicle along a first route, whose most recently carried out comparison of the pieces of surroundings information dates back the longest as compared to at least one further optional route.

19. The processing unit as recited in claim 18, wherein the processing unit is configured to update the stored pieces of surroundings information of the digital map as a function of the comparison between the detected and the stored pieces of surroundings information.

20. A system for updating a digital map for locating a motor vehicle, the system comprising:
a first processing unit;
a memory unit which stores the digital map; and
a positioning unit, the position unit including a GPS signal unit and/or a distance travel sensor and/or a direction sensor and/or a steering wheel angle sensor, the positioning unit configured to generate positioning signals of the vehicle;
a surroundings detection device, the surroundings detection device including an ultrasonic sensor and/or a camera and/or a LIDAR sensor and/or a radar sensor, the surrounding detecting device configured to detect pieces of surroundings information; and
an output unit configured to output an updated digital map;
wherein the processing unit is configured to locate the vehicle on the digital map as a function of the positioning signals and to navigate the located vehicle along a first route as a function of the stored digital map, whose most recently carried out comparison of the pieces of surroundings information dates back the longest as compared to at least one further optional route, and to compare pieces of surroundings information which are stored on the digital map to the pieces of surroundings information which are detected with the aid of the surroundings detection device to one another.
